(19) United States
(12) Patent Application Publication
(10) Pub. No.: US 2017/0372544 A1
(43) Pub. Date: Dec. 28, 2017

(54) METHOD FOR CONTROLLING ACCESS IN AN ACCESS CONTROL SYSTEM FOR PERSONS OR VEHICLES COMPRISING AT LEAST ONE ACCESS CONTROL DEVICE

(71) Applicant: SKIDATA AG, Grödig/Salzburg (AT)

(72) Inventors: Thomas SCHLECHTER, Seekirchen am Wallersee (AT); Reinhard SURKAU, Traunstein (DE)

(21) Appl. No.: 15/618,189

(22) Filed: Jun. 9, 2017

(30) Foreign Application Priority Data
Jun. 24, 2016 (EP) 16176187.9

(51) Int. Cl. G07C 9/00; H04W 4/00

(52) U.S. Cl. CPC G07C 9/00111; G07C 2009/00928; H04W 4/008

(57) ABSTRACT

A method for controlling access in an access control system for people or vehicles comprising at least one access control device (11, 12), in which verification of an access authorization is carried out by evaluation of an ID, transmitted at regular intervals by a mobile electronic device (4, 4′) by a first standard. A mobile electronic device is identified as the mobile electronic device located closest to an access control device, if a connection is established by a second standard, which has a range, which covers an area around the access control device, in which only one person or one vehicle can be located or if the mobile electronic device receives a short-range signal, which is emitted or caused by the access control device and has a range, which covers an area around the access control device (11, 12), in which only one person or one vehicle can be located.

### FILED OF THE INVENTION

The invention at hand relates to a method for controlling access in an access control system for persons or vehicles comprising at least one access control device. The invention furthermore relates to an access control system for persons or vehicles comprising at least one access control device, in particular for carrying out the method.

### BACKGROUND OF THE INVENTION

Methods and system for controlling access for persons or vehicles are known from the prior art. On principle, provision is hereby made for carrying out an access control by means of the contact-free reading of access authorizations, wherein access control devices are provided, which have means for detecting and evaluating the access authorizations as well as mechanical blocking members or otherwise configured blocking members, which are transferred automatically or manually from a blocked position into a released position after a valid access authorization is present.

As a rule, RFID reading devices are used for the contact-free reading of access authorizations, which devices comprise at least one RFID antenna unit, which communicates with RFID transponders as data carriers for reading an access authorization. In a disadvantageous manner, the range of an RFID interaction between an RFID antenna unit and an RFID transponder carried out according to the prior art is relatively small. Long-range RFID interactions take place in the microwave range and consume large quantities of energy, so that a separate power supply is required on the transponder in a disadvantageous manner for supplying power to an RFID transponder or that the RFID reading device must radiate with disproportionately high power.

It is a further disadvantage of the methods known from the prior art for controlling access by means of RFID interaction between a reading device and an RFID transponder that the number of the mobile devices, which support RFID standards, is relatively small. RFID transponders are thus often used as data carriers for access authorizations, which results in higher costs on the one hand and in the necessity for carrying a further component for the user of the access control system on the other hand.

Due to the blocking members of the used access control devices and the associated blockade of the access, the access, in particular for persons, is furthermore designed to be uncomfortable. The access control carried out in connection with the blocking members thus results in stress, whereby leisure activities are impacted significantly. In addition, the provision of the blocking members often has the result that the transport capacity of the means of transportation is not fully utilized in the case of means of transportation, which run at intervals, such as in the case of aerial railways or ski lifts.

### SUMMARY OF THE INVENTION

The invention at hand is based on the object of specifying a method for controlling access in an access control system for persons or vehicles comprising at least one access control device, the performance of which simplifies the access control. An access control system for persons or vehicles comprising at least one access control device, in particular for carrying out the method according to the invention, is to further be specified.

For a method, this object is solved by means of the features of the invention. An access control system for persons or vehicles comprising at least one access control device is the subject matter of the invention. Further embodiments and advantages according to the invention follow from the subclaims.

According to this, a method for controlling access in an access control system for persons or vehicles comprising at least one access control device is proposed, in the context of which the verification of an access authorization is carried out by means of the evaluation of an ID, which is transmitted at regular intervals by a mobile electronic device located closest to an access control device of the access control system in access direction, by means of a first standard, for example the Bluetooth Low Energy standard (hereinafter referred to as BLE) in the context of a “broadcasting”, to which ID at least one access authorization, which is received by transmitting-receiving units connected to a computer, for example a server, comprising a CPU and storage means, within ranges of the mobile electronic device, is assigned in an unambiguous manner.

A mobile electronic device in terms of the invention, which is located closest to an access control device in access direction, is a mobile electronic device, the user of which or the person, respectively, who carries it, is located in the access lane directly in front of the transition between the area covered by the access control system and the area not covered by the access control system, in the case of an access control device for persons, and which, in the case of an access control device for vehicles, is located in a vehicle in the access lane directly in front of the transition between the area covered by the access control system and the area not covered by the access control system.

According to the invention, a mobile electronic device is identified as the mobile electronic device located closest to an access control device in access direction, if a connection is established between the mobile electronic device and the access control device by means of a second standard, which has a range, which covers an area around the access control device, in which, under normal operating conditions, only one person can be located in the case of an access control system for persons, or in which, under normal operating conditions, only one vehicle can be located in the case of an recess control system for vehicles, or if the mobile electronic device receives a short-range signal, which is emitted by the access control device or is caused by the access control device, and has a range, which covers an area around the access control device, in which only one person or one vehicle can be located. The first standard has a range, which is at least as large as the range of the second standard or that of the signal emitted or caused by the access control device. In terms of the invention, the range of the signal emitted or caused by the access control device is the maximal distance to the access control device, in the case of which the signal can still be detected by a mobile electronic device.

The ID can be, e.g., a serial number of the mobile electronic device.

The use of the Bluetooth Lev Energy standard, hereinafter referred to as BLE, as first standard, results in a significantly lower power consumption than in the case of the common Bluetooth standard and, advantageously, nonetheless in a large range, which can be up to 100 meters. Every suitable standard, for example a WLAN or UWB standard, can further be used as first standard. Both latter standards are suitable to transmit the necessary information (e.g. an ID) across a sufficiently large distance, comparable to that of the BLE standard.

Compared to the first standard, for example to the BLE standard, the second standard is preferably a short-range standard. Numerous standards are possible for this, such as, for example, NFC, common RFID standards, or, e.g. the reading of a barcode by means of a scanner. In this context, a suitable standard is preferably a standard, which does not require an additional interaction with the user and which can be provided by the user without additional devices, except for the mobile electronic device, and which has the necessary smaller range than the first standard.

According to the invention, the signal emitted or caused by the at least one access control device is thus preferably a signal, which can be received by a common mobile electronic device. For example, the signal can be a signal, which can be received by a magnetic field sensor, which is already present, of a mobile electronic device, in particular of a tablet or mobile telephone. Due to the fact that the access control devices, for example access control devices in ski areas or parking columns in parking garages, are made of metal or comprise metal parts, the magnetic field around the access control devices is influenced, which can be detected by means of a magnetic field sensor, which is already present, of a mobile electronic device, for example of a mobile telephone, when if is located in the area around the access control device, in which the influencing of the magnetic field by the access control device can be detected.

Due to the fact that the influencing of the magnetic field can be detected when a predetermined distance to the access control device is ensured, which defines an area around the access control device, in which only one person or one vehicle can be located, the mobile electronic device, which detects the influencing of the magnetic field by the access control device, is the mobile electronic device located closest to the access control device in access direction. In the context of a further development, the sensitivity of the magnetic field sensor of a mobile electronic device can furthermore be adjusted in such a way that the influencing of the magnetic field can only be detected in an area around the access control device, in which only one person or one vehicle can be located.

In the context of a further embodiment of the invention, at least one electronic component, comprising at least one electromagnet, is assigned to the at least one access control device, by means of which electromagnet the magnetic field can be influenced in a specific way in a defined area around in the access control device in such a manner that this can be detected by a mobile electronic device located in this area, wherein the area is chosen in such a way that only one person or one vehicle can be located fn this area. This can in particular be advantageous, if the access control device does not have any or an insufficient amount of components, respectively, made of metal and/or if the area around the access control device, in which the influencing of the magnetic field can be detected by the access control device, is to be defined in a specific way.

The at least one electronic component can hereby be embodied and/or arranged and/or shielded in such a way that the influencing of the magnetic field can be detected in a defined angular range around the access control device. The influencing of the magnetic field can thus be detected only by mobile electronic devices, which approach in access direction of the access control device and along the access lane. In the case of an access control system comprising a multi-lane access, wherein an access control device is assigned to each access lane, the mobile electronic device located closest to the respective access control device in access direction along the access lane is determined in this way in a simple manner and with high accuracy. The at least one electromagnet of the at least one electronic component can further be controlled in such a way that the generated magnetic field has an unambiguous characteristic, which is assigned to the access control device, which can be attained, e.g., via a defined amplitude modulation, which differs from the amplitude modulation of the electromagnets assigned to the other access control devices, so as to identify the respective access control device in this way. For example, the electronic components can be integrated in the respective access control devices or can be embodied as separate components.

According to the invention, the evaluation of an ID, which is transmitted at regular intervals by an electronic device by the first standard in the context of a “broadcasting” and to which at least one access authorization is assigned in an unambiguous manner, only takes place when the electronic device has been identified as the mobile electronic device, which is located closest to an access control device in access direction. In the context of a “broadcasting” by means of the first standard, the information that a connection is established between the mobile electronic device and the access control device by means of the second standard or that the mobile electronic device receives the short-range signal, which is emitted or caused by the access control device, is hereby also transmitted.

If several persons or vehicles are located in the vicinity of an access control device, the advantage is obtained by means of the design according to the invention that an extensive and oftentimes inaccurate determination of the mobile electronic device located closest to the access control device in access direction, can be foregone.

An access control device in terms of the invention can be assigned to an inlet or an entry, respectively, or to an outlet or exit, respectively, whereby it is verified at the outlet or at the exit, respectively, whether the fee for staying in the area covered by the access control system has been paid.

In particular in the case of an access control system comprising a multi-lane access, wherein an access control device is assigned to each access lane, an ID of the access control device, which is also transmitted via the first standard in the context of the “broadcasting”, is transmitted to the mobile electronic device via the second standard when a connection is established via the second standard between the mobile electronic device and an access control device, so that the “correct” access control device, namely the access control device, to which the mobile electronic device is located closest, is identified and activated, if applicable, in order to grant access, e.g., in the case of a valid access authorization. When the determination of the mobile electronic device located closest to an access control device takes place by receiving a short-range signal, which is emitted or caused by an access control device, the signal has an unambiguous characteristic, which is also transmitted via the first standard in the context of the “broadcasting”, in order to identify the access control device, to which the mobile electronic device is located closest, in the computer, which is connected to the transmitting-receiving units by data link. The characteristics of the short-range signals emitted or caused by the respective access control device can hereby be stored in the computer or server, respectively, to which the transmitting-receiving units are connected via data link according to the first standard, in order to provide for the identification of the access control device. In the event of the active transmission of a signal or of an amplitude-modulated magnetic field, respectively, the characteristic can include the amplitude response or amplitude ratios within a defined time interval.

According to a further development of the invention, the magnetic field sensor of the mobile electronic devices located within the range of the first standard, can be activated by means of a command, which is transmitted via the first standard. In the context of an alternative of the invention, the characteristics of the short-range signals emitted or caused by the respective access control device can be transmitted via the first standard to the mobile electronic device after detection of a mobile electronic device, so that the evaluation of the signal and the identification of the access control device, to which a mobile electronic device is located closest, takes place in the mobile electronic device and the result is transmitted via the first standard to the access control system.

According to the invention, provision is made in the case of an access control system for persons or vehicles comprising at least one access control device for at least one electronic component comprising at least one electromagnet to be assigned to the at least one access control device, by means of which component the magnetic field can be influenced in a specific way in a defined area around the access control device in such a manner that this can be detected by a mobile electronic device located in this area, wherein the area is chosen in such a way that, in the case of an access control system for persons, only one person, or, in the case of an access control system for vehicles, only one vehicle can be located in this area, wherein the electronic component is embodied and/or arranged and/or shielded in such a way that the influencing of the magnetic field can be detected in a defined angular range around the access control device, whereby the influencing of the magnetic field can be detected only by mobile electronic devices, which approach, in access direction of the access control device and along the access lane and wherein the electromagnets can be controlled in such a way that the generated magnetic field has an unambiguous characteristic, which is assigned to the access control device.

In the context of a further development of the invention, it is proposed in the case of an access control device for vehicles to provide at least one magnetic field sensor, which is attached to the parking column and/or on the barrier beam, in the entry or exit, respectively, in addition or as an alternative to an induction loop, which is used according to the prior art to detect a vehicle located at a parking column in the entry or exit, respectively, and to activate the corresponding access control device. Due to the fact that vehicles have many metal parts, which influence the magnetic field around the vehicles, a vehicle located in the entry or exit, respectively, can be detected by means of the at least one magnetic field sensor. It can furthermore be detected by means of the signals of the at least one magnetic field sensor, whether the vehicle located in the entry or exit, respectively, is a large or small vehicle, so that the driver is guided to correspondingly dimensioned parking spaces, depending on the size of the vehicle. In the case of an access control system for vehicles comprising a plurality of access lanes arranged parallel to one another, two magnetic field sensors are preferably assigned to one access lane, so that an error-free determination of the access lane, in which a vehicle is located, can be realized.

The access control devices of an access control system for persons can advantageously be embodied without blocking members, wherein the access control devices can in each case have a device for detecting persons, who pass through the access control device. For example, the device for detecting persons can be embodied as light barrier or weight sensor.

When a person passes through an access control device, which is detected by means of the device for detecting persons, and if, after this person has passed through, the mobile electronic device located closest in the lane assigned to the access control device according to the method is the same as prior to the person passing through, an access without access authorization is detected and. an optical and/or acoustic signal is output.

In the alternative, the access control devices of the access control system can in each case have a blocking member, which is activated to open, when a valid access authorization is assigned to the transmitted ID of the mobile electronic devices located closest to the access control device. If, after a person has passed through, which is detected by means of a device for detecting persons or by the activation of the blocking member, that the mobile electronic device located closest in the lane assigned to the access control device according to the method is the same as prior to the person passing through, an access without access authorization is detected and an optical and/or acoustic signal is output.

### BRIEF DESCRIPTION OF THE DRAWINGS

The invention will be explained in mo so detail below by means of the enclosed figures.

FIG. 1 shows a schematic illustration of an access control device of an access control system for vehicles for illustrating the method according to the invention; and

FIG. 2 shows a schematic illustration of an access control system for persons comprising a multi-lane access, wherein an access control device is assigned to every access lane, for illustrating the method according to the invention.

### DETAILED DESCRIPTION OF THE PREFERRED EMBODIMENTS

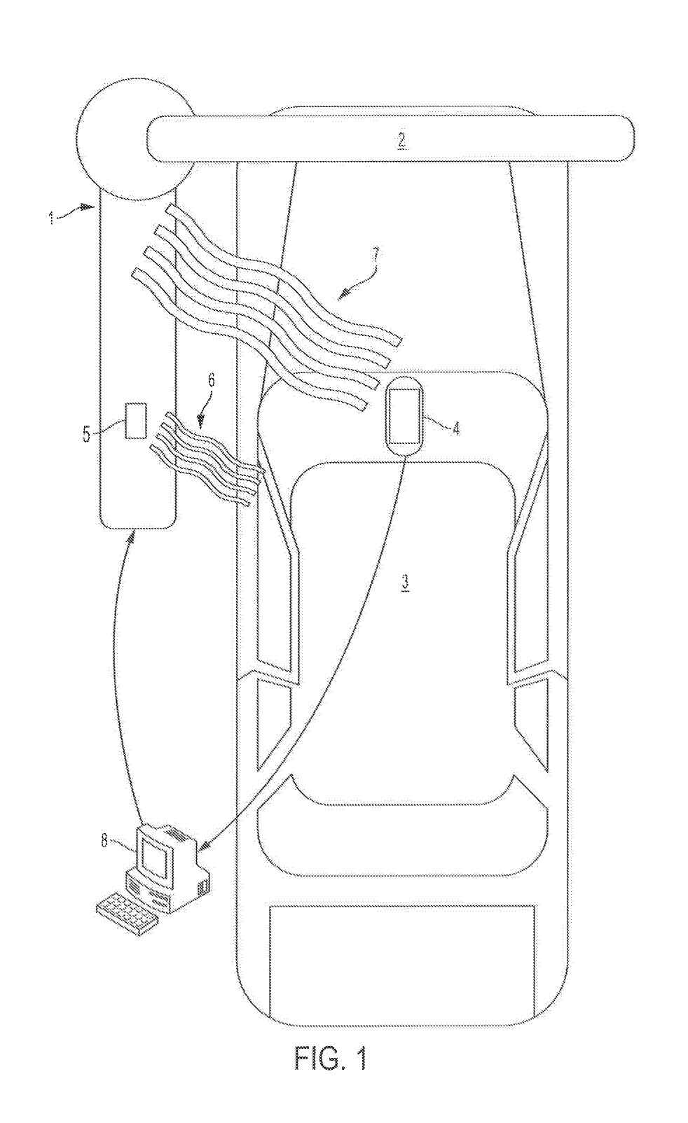

FIG. 1 illustrates an access control device for vehicles, comprising a parking column 1 and a barrier beam 2, wherein a vehicle is identified with 3. According to the invention, the verification of the access authorization for the vehicle 3 is carried out by means of the evaluation of an ID, which is transmitted at regular intervals by a mobile electronic device 4 located closest to an access control device of the access control system in access direction, by means of a first standard in the context of a “broadcasting”, to which ID at least one access authorization, which is received by means of transmitting-receiving units connected to a computer 8 comprising a CPU and storage means, within the range of the mobile electronic device 4, is assigned in an unambiguous manner.

In the shown example, a mobile electronic device 4 is identified as the mobile electronic device 4 located closest to the access control device in access direction, when the mobile electronic device 4 receives a short-range signal 7, which is emitted by the access control device or which is caused by the access control device, and has a range, which covers an area around the access control device, in which only one vehicle can be located. In the case of the shown example, the parking column is made of metal or comprises metal parts, so that the magnetic field 7 around the access control device is influenced, which is detected by a magnetic field sensor of the mobile electronic device 4, when it is located in the area around an access control device, in which the influencing of the magnetic field can be detected by means of the access control device. Due to the dimensions, only one vehicle can be located in this area.

When the mobile electronic device 4, which is located in the vehicle 3 behind the windshield in the shown example, detects the influencing of the magnetic field 7 by the parking column 1, the information that the mobile electronic device 4 receives the short-range signal, namely the influencing of the magnetic field, which is caused by the access control device, is also transmitted to the computer 8 in the context of the “broadcasting” by means of the first standard. In the context of the “broadcasting”, the ID transmitted by the mobile electronic device 4 at regular intervals is evaluated in the context of the “broadcasting”, wherein, when a valid access authorization is assigned to this ID, the access control device, which is connected to the computer 8 via a data link, is controlled in such a way that the barrier beam 2 is operated to open.

With reference to FIG. 1, the access control device has a magnetic field sensor 5, which is attached to the parking column 1 and by means of which a vehicle 3 located in the entry or exit, respectively, is detected, in addition or as an alternative to an induction loop, which is used according to the prior art to detect a vehicle located at a parking column 1 in the entry or exit, respectively, and to activate the corresponding access control device.

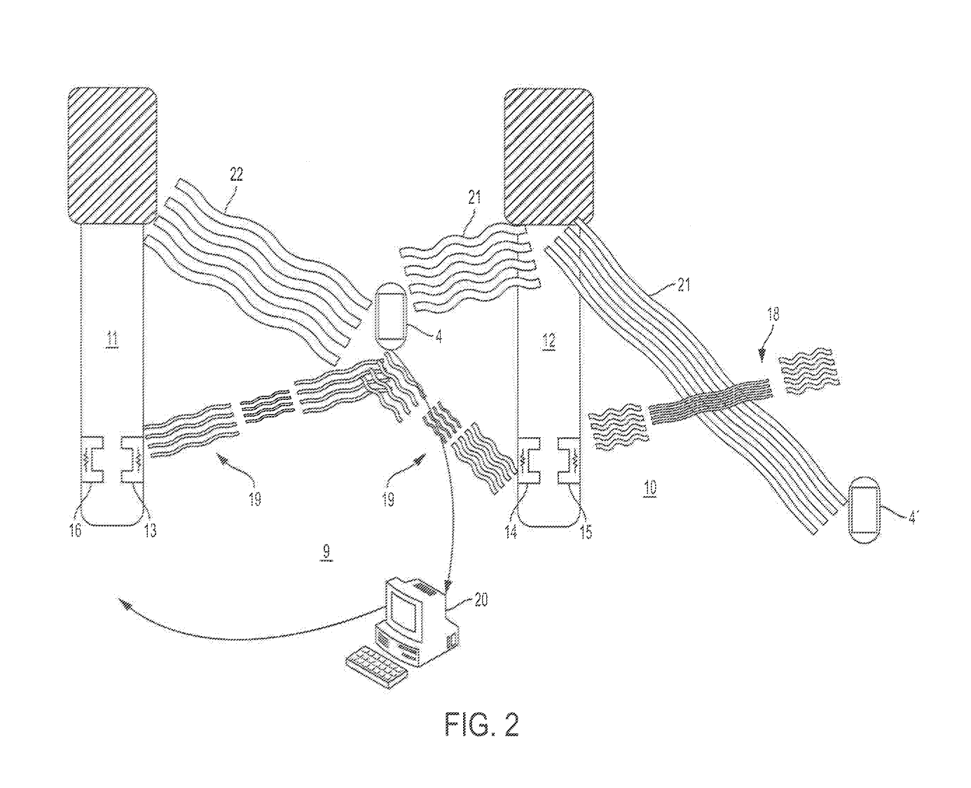

An access control system for persons comprising a multi-lane access is the subject matter of FIG. 2, wherein two access lanes 9, 10 are shown and an access control device 11, 12 is assigned to each access lane 9, 10. Two electronic components, comprising at least one electromagnet, are hereby assigned to each access control device 11, 12, by means of which electromagnet the magnetic field can be influenced in a specific way in a defined area around the access control device in such a manner that this can be detected by a mobile electronic device 4, 4′, which is located in this area, wherein the area is chosen in such a way that only one person can be located in this area. In the case of the example according to FIGS. 2, 13 and 14 identify the electronic components, which are assigned to the access control device 11, wherein 15 identifies an electronic component, which is assigned to the access control device 12; 16 furthermore identifies a further electronic component, which is assigned to a non-illustrated, further access control device. The electronic components 13, 14, 15, 16 are also embodied and/or arranged and/or shielded in such a way that the influencing of the magnetic field can be detected in a defined angular range around the respective access control device, whereby the influencing of the magnetic field can be detected only by mobile electronic devices 4, 4′, which approach the respective access control device in access direction and along the access lane. The electromagnets of the electronic components are furthermore controlled in such a way that the magnetic field generated by the electronic components, which are assigned to an access control device, has an unambiguous characteristic assigned to the access control device, which differs from the characteristic of the magnetic fields generated by the electronic components, which are assigned to the further access control devices, in order to identify the respective access control device via the characteristic of the magnetic field in this way. For example, the magnetic fields 19 generated by the electronic components 13, 14 can be amplitude-modulated in such a way that they differ unambiguously from the magnetic field 18 generated by the electronic component 15 with regard to the amplitude modulation.

According to the invention, a mobile electronic device 4 is identified as the mobile electronic device, which is located closest to the access control device 11 in access direction, when the mobile electronic device 4 receives a short-range signal 19, which, in the shown example, corresponds to the magnetic field generated by means of the electronic components 13, 14, which are assigned to the access control device 11. In the case of the shown example, two electronic components are assigned to each access control device; in the alternative, one electronic component can be assigned to each access control device.

In the case of the shown example, the mobile electronic device 4, which is embodied as smart phone, detects the magnetic field of both electronic components 13, 14, which are assigned to the access control device 11, so that, according to the invention, it is detected as the mobile electronic device, which is located closest to the access control device 11, wherein the characteristic, e.g. the amplitude response or amplitude ratios of the magnetic field are also transmitted within a defined time interval after the detection of the magnetic field in the context of the “broadcasting” via the first standard, wherein the access control device 11, to which the mobile electronic device 4 is located closest, is identified in the computer 20 by means of the characteristics. Reference numerals 21, 22 in FIG. 2 identify the magnetic fields, which are influenced by the access control devices 12, 11 and which are also detected by means of a magnetic field sensor of the mobile electronic devices, when they are located in an area around an access control device 12, 11, in which the influencing of the magnetic field by the metal parts of the access control device 12, 11 can be detected. In the shown example, however, the magnetic fields generated by means of the electronic components, which are assigned to the respective access control device, are used to determine the mobile electronic device located closest to an access control device 11, 12. In the case of a one-lane access comprising an access control device, which has metal parts, the electronic components can be forgone, because a differentiation between two or more access control devices can be forgone.

1-15. (canceled)

16. A method for controlling access in an access control system for persons or vehicles comprising at least one access control device (11,12), the method comprising:
carrying out the verification of an access authorization by the evaluation of an ID, which is transmitted at regular intervals by a mobile electronic device (4, 4′) located closest to at least one of the access control devices (11, 12) of the access control system in an access direction, by a first standard in a context of a “broadcasting,” to which ID at least one access authorization, which is received by transmitting-receiving units connected to a computer (8, 20), comprising a CPU and storage means, within ranges of the mobile electronic device (4, 4′), is assigned in an unambiguous manner,
identifying a mobile electronic device (4, 4′) as the mobile electronic device (4, 4′) located closest to the at least one access control device (11, 12) in the access direction, if a connection is established between the mobile electronic device (4, 4′) and the access control device (11,12) by a second standard, which has a range that covers an area around the access control device (11, 12), in which only one person can be located, in case of an access control system for people, or in which only one vehicle can be located, in case of an access control system for vehicles, or if the mobile electronic device (4, 4′) receives a short-range signal, which is emitted by the access control device (11, 12) or is caused by the access control device (11, 12), and has a range, which covers an area around the access control device (11, 12), in which only one person or one vehicle can be located.

17. The method for controlling access according to claim 15, further comprising providing a range for the first standard which is at least as large as a range for the second standard or that of the signal emitted or caused by the access control device (11, 12), and a range of the signal emitted or caused by the access control device (11, 12) is the maximal distance to the access control device (11, 12), in case of which the signal can still be detected by a mobile electronic device (4, 4′).

18. The method for controlling access according to claim 16, further comprising using one of a Bluetooth Low Energy standard, a WLAN or a UWB standard as the first standard.

19. The method for controlling access according to claim 16, further comprising using a Bluetooth standard as the second standard.

20. The method for controlling access according to claim 16, further comprising emitting or causing to be emitted a signal by the at least one access control device (11, 12) which can be received by a magnetic field sensor of a mobile electronic device (4, 4′).

21. The method for controlling access according to claim 20, further comprising, in case of access control devices (11, 12) which are made of metal or comprise metal parts, influencing a magnetic field around the access control devices (11, 12), which can be detected by a magnetic field sensor of a mobile electronic device (4, 4′), when it is located in an area around an access control device (11, 12), in which the influencing of the magnetic field by the access control device (11, 12) can be detected.

22. The method for controlling access according to claim 20, further comprising assigning at least one electronic component (13, 14, 15, 16), comprising at least one electromagnet, to the at least one access control device (11, 12), by which the electromagnet of the magnetic field can be influenced in a specific way in a defined area around in the access control device (11, 12) such that this can be detected by a mobile electronic device (4, 4′) located in this area, and
choosing the area such that only one person can be located in this area, in the case of an access control system for people, or only one vehicle, in the case of an access control system for vehicles.

23. The method for controlling access according to claim 22, further comprising embodying, arranging or shielding the at least one electronic component (13, 14, 15, 16) such that the influencing of the magnetic field can be detected in a defined angular range around the access control device (11, 12), whereby the influencing of the magnetic field can be defected only by a mobile electronic device (4, 4′), which approach in the access direction of the access control device and along an access lane.

24. The method for controlling access according to claim 22, further comprising controlling the electromagnets such that the generated magnetic field has an unambiguous characteristic, which is assigned to the access control device (11, 12).

25. The method for controlling access according to claim 18, further comprising in a context of a “broadcasting” by means of the first standard, the information that a connection is established between a mobile electronic device (4, 4′) and the access control device (11, 12), by the second standard, or that a mobile electronic device (4, 4′) receives the short-range signal, which is emitted or caused by the access control device (11, 12), is transmitted, wherein, in the case of an access control system comprising a multi-lane access, wherein an access control device (11, 12) is assigned to each access lane, an ID of the access control device (11, 12), which is also transmitted via the first standard in the context of the “broadcasting,” is transmitted to the mobile electronic device (4, 4′) via the second standard when a connection is established via the second standard between the mobile electronic device (4, 4′) and an access control device (11, 12), so as to identify the access control device (11, 12), to which the mobile electronic device (4, 4′) is located closest, when the determination of the mobile electronic device (4, 4′) located closest to an access control device (11, 12) takes place by receiving a short-range signal, which is emitted or caused by an access control device (11, 12), the signal has an unambiguous characteristic, which is also transmitted via the first standard in the context of the “broadcasting,” in order to identify the access control device (11, 12), to which the mobile electronic device (4, 4′) is located closest, or which is evaluated in the mobile electronic device (4, 4′), and the result is also transmitted in the context of the “broadcasting” via the first standard.

26. The method for controlling access according to claim 16, further comprising making provision, in a case of an access control device for vehicles, for at least one magnetic field sensor (5), which is attached to a parking column (1) and/or on a barrier beam (2), at an entry or an exit, respectively, in addition or as an alternative to an induction loop, which is used to detect a vehicle located at a parking column (1) in the entry or the exit, respectively, and to activate the corresponding access control device, and a vehicle (3) located in the entry or the exit, respectively, is detected by the at least one magnetic field sensor (5).

27. The method for controlling access according to claim 26, further comprising detecting by the signals of the at least one magnetic field sensor (5), whether the vehicle (3) located in the entry or the exit, respectively, is a relatively large vehicle or a relatively small vehicle (3), and guiding a driver of the vehicle to a correspondingly dimensioned parking space, depending upon a size of the vehicle (3).

28. The method for controlling access according to claim 16, wherein in the case of an access control system for people, the at least one access control device (11, 12) does not have a blocking member, when a person passes an access control device (11, 2), this is detected by a device for detecting people, and, if, after this person has passed through, the mobile electronic device (4, 4′) located closest in the lane (9, 10) assigned to the access control device (11, 12) is the same as prior to the person passing through, an access without access authorization is detected and outputting an optical and/or acoustic signal.

29. The method for controlling access according to claim 16, wherein, in the case of an access control system for people, the at least one access control device (11, 12) has a blocking member, which is activated to open, when a valid access authorization is assigned to the transmitted ID of the mobile electronic devices located closest to the access control device (11, 12), when a person passes through an access control device (11, 12), this is detected by a device for detecting people or by the activation of the blocking member, and, after this person has passed through, the mobile electronic device (4, 4′) located closest in the lane (9, 10) assigned to the access control device (11, 12) is the same as prior to the person passing through, an access without access authorization is detected and outputting an optical and/or acoustic signal.

30. An access control system for people or vehicles comprising at least one access control device (11 12) for carrying out the method according to claim 16, wherein at least one electronic component (13, 14, 15, 16), comprising at least one electromagnet, is assigned to the at least one access control device (11, 12), by which electromagnet the magnetic field can be influenced in a specific way in a defined area around in the access control device (11, 12) such that this can be detected by a mobile electronic device (4, 4′) located in this area, the area is chosen such that only one person can be located in this area in the case of an access control system for people or only one vehicle in the case of an access control system for vehicles, and the electronic component (13, 14, 15, 16) is embodied and/or arranged and/or shielded such that the influencing of the magnetic field can be detected in a defined angular range around the access control device (11, 12), whereby the influencing of the magnetic field can be defected only by mobile electronic devices (4,4′), which approach in an access direction of the access control device (11, 12) and along an access lane and the electromagnets is controlled such that the generated magnetic field has an unambiguous characteristic, which is assigned to the access control device (11, 12).
